(19) United States
(12) Patent Application Publication
(10) Pub. No.: US 2006/0266716 A1
(43) Pub. Date: Nov. 30, 2006

(54) Equipment dryer

(76) Inventor: Alan J. Perry, Bridgeport, NY (US)

Correspondence Address: BERNHARD P. MOLLDREM, JR., 224 HARRISON STREET, SUITE 200, SYRACUSE, NY, 13202, US

(21) Appl. No.: 11/438,972

(22) Filed: May 23, 2006

Related U.S. Application Data
(60) Provisional application No. 60/683,084, filed on May 23, 2005.

(51) Int. Cl. E05B 73/00

(52) U.S. Cl. 211/9

(57) ABSTRACT

An equipment drying rack for athletic gear has the form of an A-frame with left and right legs that meet at an apex, and a cross arm. These are joined with removable snap-in pins, so the rack can be quickly assembled and taken down, and stuffed compactly into a bag for travel. The rack can be wall mounted or a back leg can be installed for free-standing floor use. Hanging pegs can be removably plugged into sockets on the side legs, cross arm, and back leg.

This application claims priority of U.S. Provisional Application No. 60/683,084, filed May 23, 2005.

### BACKGROUND OF THE INVENTION

This invention concerns a drying rack for holding athletic equipment or other garments and the like to permit drying by air circulation, and is more particularly concerned with a drying rack of a simple design that can be permanently wall mounted, temporarily wall mounted, floor mounted, or taken down into compact form for portability.

The invention is more particularly directed to an equipment air drying rack for drying of athletic equipment, but may also be used for protective garments for outdoor or industrial use, i.e., by athletes, factory workers, outdoor workers, or any of a variety of others.

To date, there have been no convenient wall-mounted drying racks for lacrosse equipment, football equipment, hockey equipment or the like. There have been several proposed versions of portable drying equipment, but these lack compactness when folded down for transport, and can be used only as floor standing racks.

Allman U.S. Pat. No. 6,073,783 describes one type of drying rack for athletic equipment, which can be opened out and used as a free standing rack, and can be folded down and rolled into a closet or storage area. Dumont U.S. Pat. No. 5,863,924 shows another floor mounted equipment drying rack. De Rocher et al. Publication US 2002/0005390 shows a tripod style drying rack for scuba dive equipment.

### OBJECTS AND SUMMARY OF THE INVENTION

Accordingly, it is an object of the present invention to provide a drying rack that can be folded down and stored in a travel bag for portability, and which can be used either as a free-standing floor rack, or as a wall-mounted drying rack.

It is another object to provide a drying rack of a simple and straightforward design that is simple to take down and set up, and which can hold a player's athletic equipment, i.e., helmet, pads, shoes, gloves and uniform, to permit air drying.

Likewise, it is an object to provide a device that can be temporarily, permanently, or semi-permanently mounted on a wall (or other vertical surface).

In accordance with an aspect of this invention, a drying rack for athletic equipment or the like, is in the form of an A-frame, with left and right leg members that meet at the apex to form an inverted Vee. The leg members are removably attached to one another at the apex. A cross-arm member has left and right ends removably attached to receptacle portions of the left and right leg members, respectively. There are a number of peg members removably fitted into the left and right leg members and into said cross-arm member, adapted for holding items of athletic equipment for air drying.

The left and right ends of cross-arm member have ends cut away at one side to form struts for mounting to the leg portions. The receptacle portions of said leg members have mating notches or recesses therein into which said struts fit. The cross-arm member is of a predetermined front to back thickness, and struts favorably have portions with a depth of one half that thickness, projecting at the respective ends of the cross-arm member. In that case, the receptacles on the leg portions are in the form of cutouts with a depth equal to the depth of these struts.

As a means of removably holding the parts of the A-frame together, snap-in pins are used. The struts have pin openings in them and left and right leg members each have corresponding pin openings at aligned positions in the recesses. The removable snap-in pins fit into the aligned openings. Another pin fits into aligned pin openings at of the two leg members at the apex.

As a means to allow the rack to be mounted on a wall, there are an upper nail hanger opening at the apex of the A-frame and a lower nail hanger opening at a center of the cross-arm member. For more permanent mounting on the wall, there are provided left and right mounting openings in the left and right leg members at positions that are of equal height, i.e., at the same vertical distance from said apex, and horizontally separated by substantially sixteen inches, so the rack can be mounted using fasteners screwed into wall studs.

For free-standing floor use, a removably insertable rear support leg is provided. This rear leg has a pair of forwardly directed pins at an upper end thereof; the left and right leg members have corresponding apertures respectively therein in which said pins are removably inserted for holding the rear support leg in place.

In a favorable implementation, the peg members for hanging the equipment each include a rectangular tenon portion at the back and a dowel portion projecting forward therefrom. The left and right leg members and the cross-arm member are provided with rectangular sockets adapted for receiving and holding these rectangular tenon portions of the peg members.

The rack can be easily set up, as there are only three major parts of the A-frame plus the one back leg, which is only needed for floor use. The left and right legs are placed together at the apex and one of the pins is pushed in. Then the cross-arm member is fitted in place and secured by pushing in two more of these pins. The pegs are pushed into the sockets as needed, and the rack is held in place on a wall, or else the back leg is quickly snapped into position for free standing floor use.

To ready the rack for transport, all that is needed is to pull off the back leg, and pull out the pins from the apex and from the ends of the cross-arm member. The equipment hanger pegs can be removed. The long pieces, i.e., the side legs, the back leg, and the cross arm, stack together compactly and fit into a nylon equipment bag, and the smaller parts, i.e., the pegs can also be placed in the nylon bag. The snap-in pins are most favorably leashed to the long pieces, with flexible nylon strapping similar to what is commonly used in cable ties or wire ties.

The rack is simple to employ and conveniently compact for travel use.

The most desirable use of the rack is to provide a place for athletes to hang their wet, sweaty, and possibly muddy pads, helmets, shoes, and other items of athletic gear that they may wear in practice or in a game, and which may be difficult to wash between uses. This easily applies to sports like lacrosse, hockey, or football, and to any other sport where the equipment needs to be aired out between uses. By allowing the equipment to dry out, odors and bacteria are suppressed, and the equipment is ready to use the next time needed.

The general design shown and described is intended for a lacrosse player, but with only minor modifications a rack of the same principle can be used for other sports. Pegs are provided for the player's helmet, arm pads, gloves, shoulder pads, rib pads, and cleats. Two pegs at the bottom can be used to hold the lacrosse stick horizontally. There are numerous peg locations, so the positions of the pegs can be adjusted, as need be, with more or fewer pegs than shown. The racks are favorably formed of a molded plastic, such as a polycarbonate, so they are extremely strong and durable.

The rack has different mounting options. One option is for temporary mounting onto a wall, and another option is for permanent mounting to a wall. A third option is a free-standing position for floor use, employing the optional back leg. This option makes the unit portable, and convenient for use when traveling, i.e., in conjunction with tournament play. This mode can also be used for non-typical applications.

For the one wall mounting option, the equipment drying rack is mounted to a wall, e.g., a garage wall, cellar wall, or bedroom wall, or dorm wall. Here it can be permanently mounted using the two smaller holes provided, which are a nominal sixteen inches apart. This way, the unit can be mounted tightly to a wall using screws that go into the wall studs.

The unit can also be hung (temporarily) onto two nails positioned one over the other in a wall stud. For this, the rack has two larger diameter nail hanging holes. This makes it simple to mount the rack at that location, but also simple to take it down from the wall for travel.

The free-standing option, which is the usual portable option, makes the rack especially versatile. The three snap-in pins are removed so the A-frame can be disassembled, making it much more compact and easier to transport. These pins are leashed with a nylon fastener to keep them attached to the frame so they stay with the unit and are not lost. The rack can then be placed into a nylon carry bag, which may have a shoulder strap. This is typically the same bag where items of the athletic equipment are also kept. The bag containing the dryer rack can now be easily transported in a vehicle or simply carried over the shoulder. The rack is durable, lightweight, and compact.

When the athlete arrives at the destination he or she is visiting, the rack is removed from the bag and can be easily assembled, using the snap-in pins, placing the left and right legs and the cross bar back into an A-frame. The pins lock the pieces together. The pieces have ends that are half the thickness of the remainder of the pieces. When the two pieces are placed together, they can only be assembled one way, and make a tight fitting connection. The third leg is then inserted into the back of the A-frame, making the rack into a tripod. The back let has peg receptacles also, so that pegs can be inserted into it, and used to hang other items of equipment, e.g., face mask, nylon carry bag, etc, so all the equipment can be kept together.

The free-standing rack can be used on any floor or flat horizontal surface. The wide base makes the item very sturdy and stable. When traveling, e.g., to a tournament, where there are several games scheduled over a few days, the rack can be quickly set up for use between or after the games.

The rack can also be set up in a van, in the back of a truck, along side a playing field, in a hotel room, or elsewhere when needed. This allows the equipment to be aired out between uses, rather than being stuffed in a bag and remaining wet. Natural flow of air allow the moisture to escape from the equipment, plus sun and wind can speed up the drying process. The long legs help keep the equipment from hanging down and contacting the ground.

The equipment dryer rack provides an ideal means for holding the equipment when it is removed wet from a bag, as it allows the items to dry out naturally between uses so it can be comfortably placed back on the body the next day, or replaced in the equipment bag for the next outing. When the equipment is next needed, it will be dry, and will not have shrunk, as can occur using conventional drying methods. There is no additional cost involved in drying the equipment.

The above and many other objects, features, and advantages of this invention will be more fully appreciated from the ensuing description of selected preferred embodiments, with the description to be read in conjunction with the accompanying Drawing.

### BRIEF DESCRIPTION OF THE DRAWING

FIG. 1 is a front perspective view of the drying rack according to an embodiment of the invention.

FIG. 2 is another front perspective view of this embodiment, configured for wall mounting.

FIG. 3 is a side assembly view.

FIG. 4 is a top view, showing features of the rear support leg.

FIG. 5 is a side view of an equipment holder peg.

FIG. 6 is a rear view thereof.

FIG. 7 is top view thereof, taken at 7-7 of FIG. 1.

FIG. 8 shows a snap-in removable pin employed in this embodiment.

FIG. 9 is an assembly view of portions of this embodiment.

### DETAILED DESCRIPTION OF THE PREFERRED EMBODIMENT

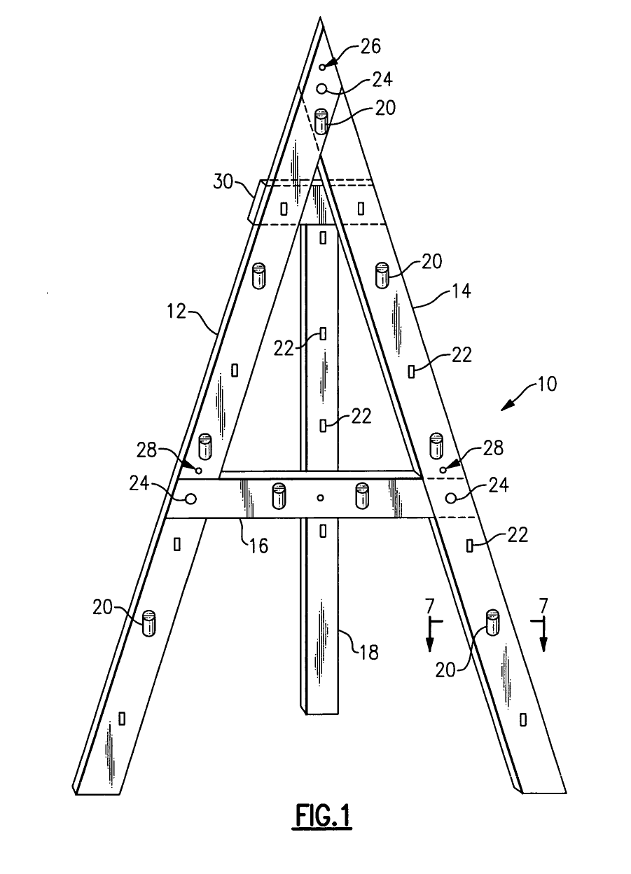

With reference now to the Drawing, and initially to FIG. 1 a portable drying rack 10 is shown in a front perspective, and is generally in the form of an A-frame, with left and right legs 12, 14 that are spread apart at the base and are joined at an apex, and a generally horizontal cross-arm or cross-bar 16 that joins the two legs at a position just below the center (considered from top to bottom). The preferred embodiment as shown may be supported on a floor or horizontal surface, or may be mounted onto a vertical surface, such as a wall. In the floor or free-standing configuration, as shown, a third or rear leg 18 is attached to the two other legs 12, 14 at or near the apex, and forms a three-legged or tripod assembly. The top or head 30 of the rear leg 18 can be easily inserted or detached, as described below.

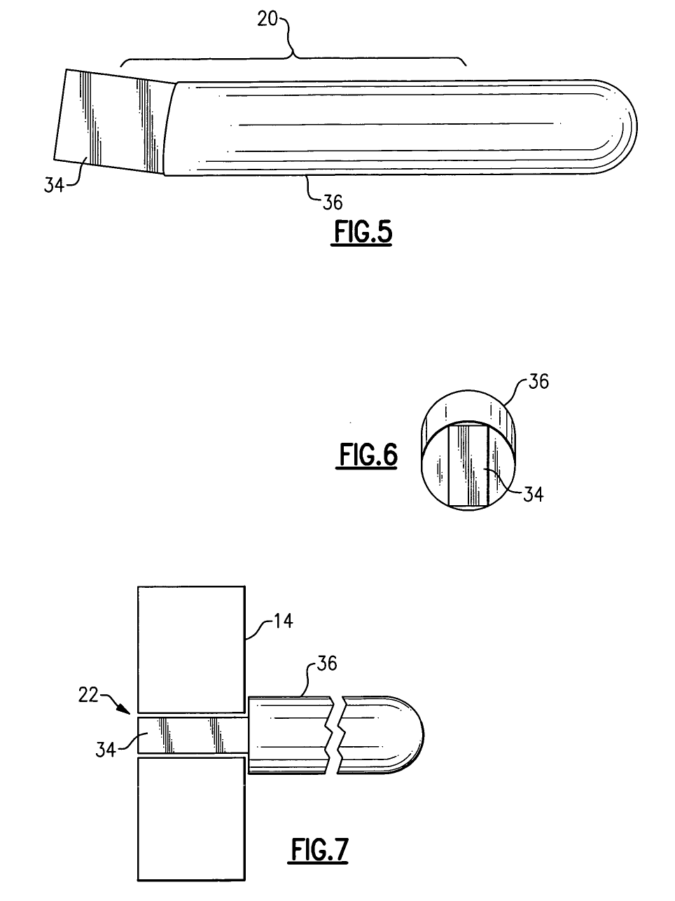

There are a number of removable pegs 20 that can be placed at positions on the side legs 12, 14, the cross-arm 16, and on the rear leg 18 and there provide places for the athlete to hang the items of equipment. There are a number of rectangular sockets or apertures 22 provided along each of these members, and the pegs 20 can be installed where needed. Details of these pegs and sockets will be described later in reference to FIGS. 5, 6, and 7.

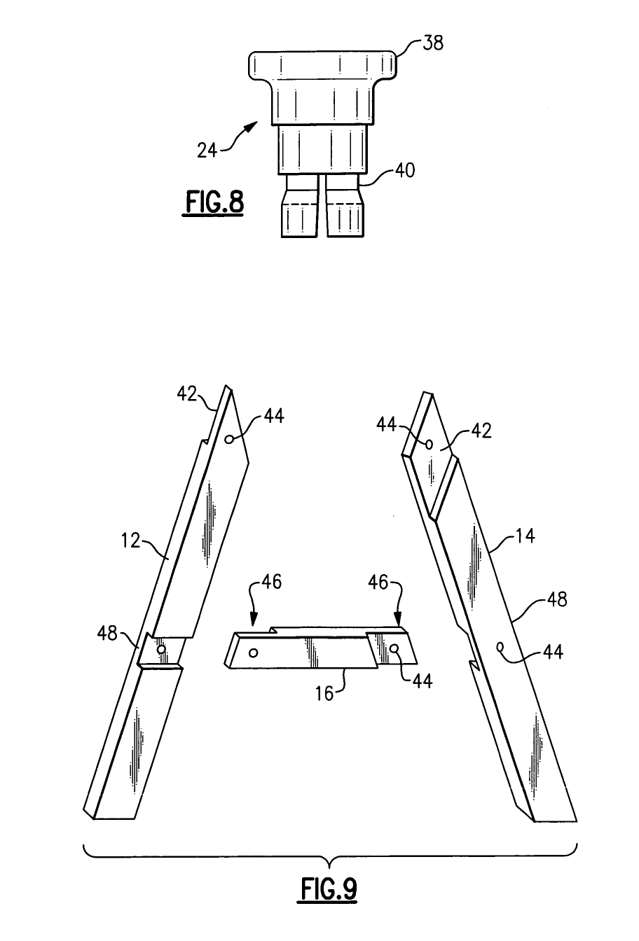

There are also removable snap-in pins 24 that are used to secure the upper ends of the left and right legs 12, 14 at the apex, and to secure the left and right ends of the cross-arm 16 to receptacles on the left and right legs 12, 14. These will be described in more detail below with reference to FIGS. 8 and 9.

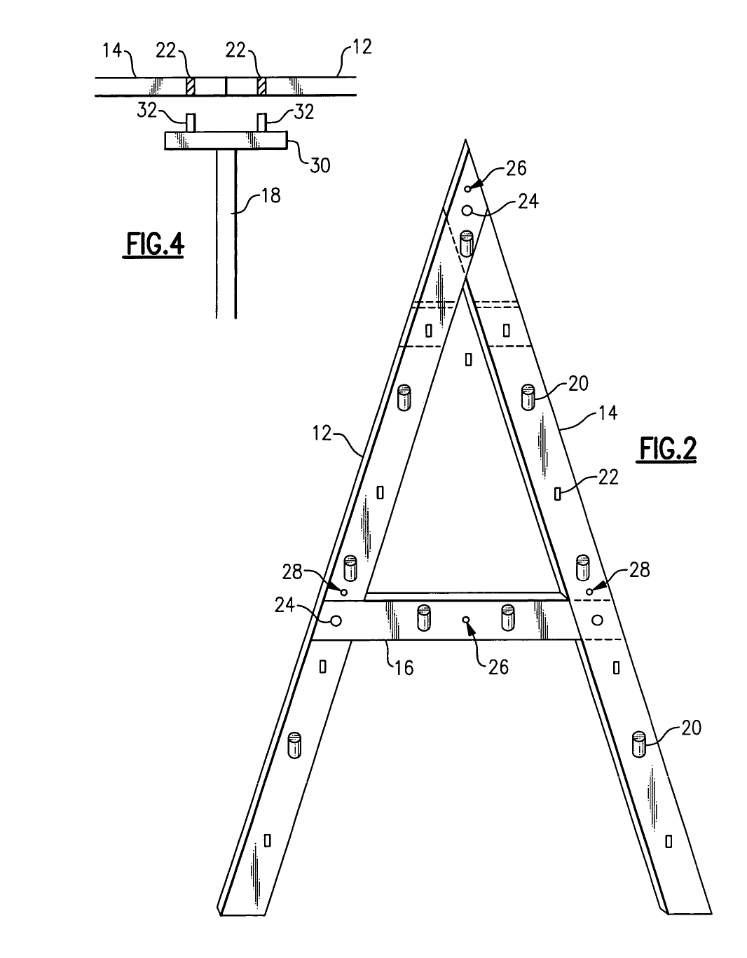

As shown in FIG. 2, the rack 10 can be configured for temporary or permanent mounting on a vertical surface, by omitting the rear leg 18. For temporary wall mounting, there are a pair of nail hanger holes 26, 26 positioned in vertical alignment, with one nail hole 26 at the apex and the other nail hole 26 at the center of the cross-arm 16. These are of a sufficient diameter, e.g., ¼ inch, so that they can be easily placed on a pair of nails or similar fasteners, and then can be easily taken down when the rack is needed for travel.

For more permanent installation, there are a pair of smaller-diameter apertures 28, 28 positioned on the two side legs 12, 14 at the same vertical location, i.e., the same distance from the apex so that the holes are in horizontal alignment. These are at a standard wall-stud center distance, i.e., a nominal sixteen inches apart. The A-frame rack 10 can be secured to the wall by installing screws here, which can be screwed into the wall studs.

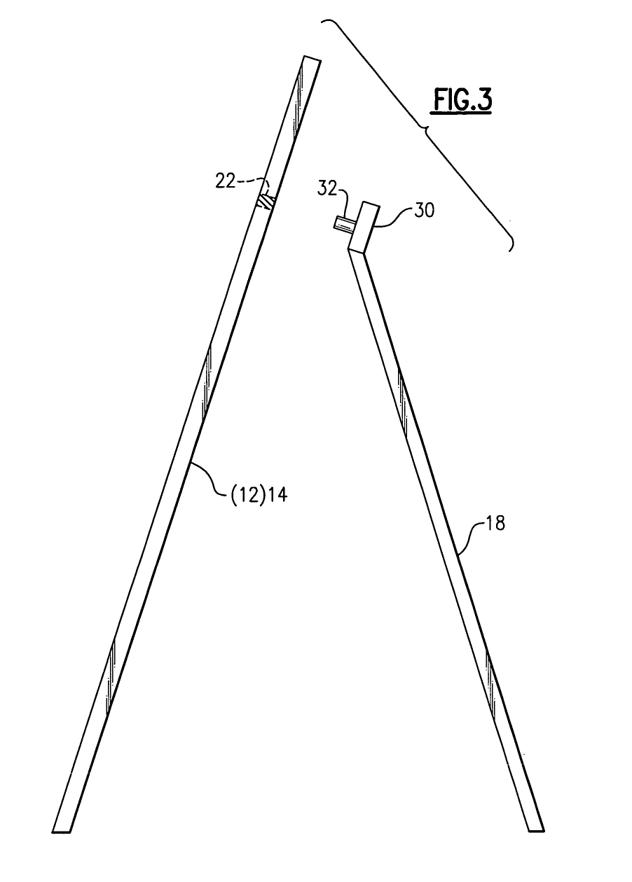

The details of the back leg 18, which is needed for the free-standing floor configuration, are shown in FIGS. 3 and 4. The leg 18 has a transverse head member 30 formed on it, with a pair of rectangular pegs 32, one to the right and one to the left. These pegs 32 each fit into a respective one of the rectangular sockets 22 near the top end of the side leg 12 or 14. The head member 30 is angulated back about thirty degrees from the rear leg 18, so that the rear leg opens back at about that angle. Other embodiments can have different angles for the rear leg.

The pegs 20 for hanging the items of equipment and athletic gear are shown in FIGS. 5, 6, and 7. Each peg has a back or distal portion in the form of a tenon 34 of rectangular profile, and a forward or proximal portion in the form of a generally cylindrical dowel 36. The dowel portion 36 is shown here tilted upward in respect to the tenon 34. The tenon 34 is shaped to fit snugly into any of the rectangular sockets 22. The rack 10 is provided with a sufficient number of these equipment hanger pegs 20 so that they can be installed where desired along the side legs, the back leg, and the cross-arm. The locations of the sockets are the same on the right and left legs, so that a pair of these pegs can be installed at the same vertical position, one in each leg, for holding a long piece of equipment horizontally, e.g., a lacrosse stick or hockey stick.

A supply of additional pegs 20 can be purchased separately at a reasonable price so that the athlete can replace these if they become lost or damaged. These pegs may alternatively be in the form or hooks or clamps.

FIG. 8 shows an example of the removable, snap-in pin 24 that is used to hold the long pieces together, i.e., the side legs and the cross-arm. The pin 24 is generally cylindrical in shape, with a flanged head 38 to facilitate pushing the pin into the openings provided and for pulling it out to dismantle the A-frame for travel. The distal end 40 of the pin is split into a number of resilient flared-out legs that snap into place to hold the legs and cross-arm securely, but yield if the head 38 pulled firmly.

Details of the side legs 12 and 14 and of the cross-arm 16 are shown in the exploded or assembly view of FIG. 9. The left and right legs 12, 14 each have a cutaway portion at the apex, leaving struts 42 that project or extend from the ends of the main parts of the legs. Each of the legs 12, 14 is of a generally rectangular profile, with a width of e.g., three inches and a depth or thickness (front-to-back) e.g., of one inch. The struts 42 are one half that thickness or depth, i.e., three-inches by one-half inch. The cutout and strut 42 are somewhat diamond shaped, so as to mate with the strut of the other leg so they can be assembled easily together. Each strut has a pin hole opening 44 to receive one of the snap-in pins 24, and these two openings are aligned at the apex. Each side leg has a channel or cutout 48 that extends from left to right across the leg, and this is one-half the depth of the leg, so the channel 48 is dimensioned about three-inches by three-inches by one-half inch. The cross-arm 16 has cutouts or recesses at its left and right ends, so as to form struts 46 that mate into the channels 48 formed in the side legs. That is, the channels 48 serve as receptacles for receiving the ends of the cross-arm. There are pin hole apertures 44 formed in the struts and at aligned positions in the channels 48, so these pieces can be locked in place by inserting the snap-in pins 24.

Note, here the cross-arm 16 has the left strut 46 at the front side and the right strut at the rear, and the left leg 12 has its channel 48 at the front while the right leg 14 has its channel 48 formed at the rear. The left and right legs 12 and 14 are identical in shape, and the cross-arm 16 is symmetrical and so it can be turned end for end and still installed. This means these three pieces, i.e., legs 12, 14 and cross-arm 16 can be assembled one way, making a tight-fitting connection. The sockets 22 pass all the way through these members. When these three are assembled together, the rear leg 18 can be snapped into place to form a stable tripod.

When the athlete needs to take the dryer rack apart for travel, the rear leg 18 and the pegs 20 can be easily pulled out and stored in a nylon carry bag. The three snap-in pins 24 can be pulled out from the pin hole apertures 44, and the three long parts 12, 14, 16 placed compactly into the same mesh bag. The pins 24 can be attached with a nylon leash or strap to the side legs so they do not become lost or misplaced.

In one favorable embodiment, the A-frame rack has a base of about thirty-six inches for good stability, and a height (from base to apex) of about sixty inches, which is sufficient to keep the equipment hanging down from it from draping onto the floor.

In alternative embodiment, suction cups (not shown) can provide for temporary mounting on a window or on another smooth vertical surface.

Also, one of the pegs or holders can be used for holding a mesh bag, e.g., for lacrosse balls, or for the carry bag that is used in transporting the rack.

In other possible embodiments, the apex may be hinged, and the cross bar can lift up at one side, so the A-frame rack can be folded together.

A polycarbonate is used here for the A-frame rack, but many other plastics could be used. Also, the rack could be of a light-weight aluminum construction, or of fiber construction.

As mentioned before, the same concepts can be applied to other sports equipment which may or may not involve storing a stick or racket, or for equipment for other indoor or outdoor activities.

While the invention has been described with reference to a specific preferred embodiment, the invention is certainly not limited to that precise embodiment. Rather, many modifications and variations will become apparent to persons of skill in the art without departure from the scope and spirit of this invention, as defined in the appended claims.

1. Drying rack for athletic equipment or the like, comprising
an A-frame which is formed of left and right leg members removably attached to one another at an apex thereof, and a cross-arm member with left and right ends removably attached to receptacle portions of the left and right leg members, respectively; and
a plurality of peg members removably fitted into said left and right leg members and into said cross-arm member, the peg members being adapted for holding said athletic equipment for air drying.

2. The drying rack of claim 1 wherein the left and right ends of said cross-arm member have struts formed thereon and said receptacle portions of said leg members include recess therein into which said struts mate.

3. The drying rack of claim 2 wherein said cross arm is of a predetermined front to back thickness, and struts include portions having a depth of one half said thickness projecting at the respective ends of the cross-arm member, and wherein said receptacles include cutouts with a depth equal to the depth of said struts.

4. The drying rack of claim 3 wherein said struts have pin openings therein and said left and right legs have pin openings at aligned positions in said recesses, the drying rack further including a plurality of removable snap-in pins fitting into said aligned openings.

5. The drying rack of claim 4 comprising an upper nail hanger opening at the apex of said A-frame and a lower nail hanger opening at a center of said cross-arm member.

6. The drying rack of claim 1 comprising left and right mounting openings in said left and right leg members a positions that are the same vertical distance from said apex and horizontally separated by substantially sixteen inches.

7. The drying rack of claim 1 comprising a removably insertable rear support leg, including a pair of forwardly directed pins at an upper end thereof, and said left and right leg members having apertures respectively therein in which said pins are removably inserted for holding said rear support leg in place.

8. The drying rack of claim 7, wherein said peg members each include a rectangular tenon portion and a dowel portion projecting forward therefrom; and said left and right leg members and said cross-arm member are provided with rectangular sockets adapted for receiving and holding said tenon portions of the peg members.
